(19) United States
(12) Patent Application Publication
(10) Pub. No.: US 2005/0038556 A1
(43) Pub. Date: Feb. 17, 2005

(54) Automated instrument sorting system

(75) Inventors: Alain Gagnon, Quebec (CA); Andre Delisle, St. Nicolas (CA)

Correspondence Address: KUSNER & JAFFE;HIGHLAND PLACE SUITE 310, 6151 WILSON MILLS ROAD, HIGHLAND HEIGHTS, OH, 44143, US

(73) Assignee: STERIS Inc.

(21) Appl. No.: 10/639,721

(22) Filed: Aug. 12, 2003

(51) Int. Cl. G06F 7/00

(52) U.S. Cl. 700/226

(57) ABSTRACT

An automated system for sorting articles, such as medical instruments, by a selected sort criteria. In one embodiment of the present invention, medical instruments are sorted in accordance with an instrument set list for assembling a medical instrument set. The present invention minimizes or eliminates the amount of manual labor needed to sort instruments, minimizes human contact with the instruments, speeds the sorting process, and reduces sorting errors.

### FIELD OF THE INVENTION

The present invention generally relates to an automated system for article sorting, and more particularly to a system for automated sorting of medical instruments by a selected sort criteria.

### BACKGROUND OF THE INVENTION

Surgical instruments used in a medical procedure will have a significant effect on the quality and success of that medical procedure. Between each medical procedure, the instruments must undergo one or more biocontamination reduction processes (e.g., washing, disinfection, sterilization, decontamination, and the like), and be assembled into correct and complete instrument sets, in advance of a medical procedure. Each instrument set is comprised of a predetermined group of instruments appropriate for a type of medical procedure. Exemplary medical instrument sets include major basic surgery set, minor basic surgery set, infant laparotomy set, gynecological surgery set, basic orthopedic surgery set, basic podiatry set, etc. Each of these medical instrument sets includes different numbers and types of medical instruments.

Instrument sets become disassembled and unsorted following a medical procedure and/or during a biocontamination reduction process. After a medical procedure, instruments are typically deposited at a central collection site where they get mixed with instruments used in other medical procedures. With respect to a biocontamination reduction process, individual instruments may require different procedures (e.g., hand wash versus machine wash), or be loaded into different racks or containers associated with a biocontamination reduction device.

In most organizations, instrument “technicians” or “assemblers” are responsible for instrument care and handling. An instrument assembler must identify different types of instruments, assemble instrument sets according to a predetermined list of instruments, and know how each instrument should be processed for biocontamination reduction. Assembly of instrument sets is a tedious and time consuming process.

In order to provide proper instrument care and handling, an instrument assembler must be properly trained in basic instrument identification, and biocontamination reduction procedures. Instrument identification is made difficult by the fact that there are numerous different instruments, and many of the instruments look very similar. To facilitate identification, instruments may be marked with identifiers that correspond with instrument set component lists and instrument catalogs.

There is also a need for tracking the use and inventory of surgical instrument sets. In this regard, surgical instruments may become lost (e.g., misplaced or stolen), or need repair.

The present invention addressed these and other problems by providing an automated system for sorting medical instruments into sets according to a sort criteria.

### SUMMARY OF THE INVENTION

In accordance with the present invention, there is provided a method for processing medical instruments undergoing at least one biocontamination reduction process, comprising the steps of: (a) locating a plurality of medical instruments onto a conveyance means; (b) conveying each of the medical instruments past imaging means; (c) reading a machine-readable code located on each medical instrument to determine a destination site associated with the medical instrument; and (d) conveying each medical instrument to the destination site associated therewith, wherein each destination site collects a set of medical instruments according to a sort criteria.

In accordance with another aspect of the present invention, there is provided a system for automated sorting a plurality of medical instruments, comprising: (a) a sorting apparatus including conveyance means for conveying each of the medical instruments to a destination site to collect a set of medical instruments in accordance with a sort criteria; (b) an imaging system for reading a machine-readable code located on each medical instrument; and (c) a tracking system for determining a destination site using the machine-readable code, and transmitting destination site data to the sorting apparatus that identifies the destination site associated with the medical instrument.

An advantage of the present invention is the provision of an automated sorting system and method that minimizes human involvement in the instrument sorting and set assembly processes.

Another advantage of the present invention is the provision of an automated sorting system and method that minimizes human contact with medical instruments.

Another advantage of the present invention is the provision of an automated sorting system and method that reduces the risk of error in assembly of instrument sets.

Another advantage of the present invention is the provision of an automated sorting system and method that reduces the risk of losing instruments.

Still a further advantage of the present invention is the provision of an automated sorting system and method that reduces costs associated with instrument sorting.

Still a further advantage of the present invention is the provision of an automated sorting system and method that provides computerized instrument tracking.

Yet another advantage of the present invention is the provision of an automated instrument sorting system and method that sorts instruments in accordance with a user-selectable sort criteria.

Yet another advantage of the present invention is the provision of an automated instrument sorting system and method that facilitates paperless data management.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a schematic illustration of an automated sorting system, according to a preferred embodiment of the present invention;

FIG. 2 is a block diagram of the tracking system of the automated sorting system of FIG. 1;

FIG. 3 is a flow diagram illustrating operation of the automated sorting system;

FIG. 4 is a flow diagram illustrating transport logistics of instruments, according to a preferred embodiment of the present invention; and

FIG. 5 is a perspective view of a portion of an instrument having a machine-readable code located thereon.

### DETAILED DESCRIPTION OF A PREFERRED EMBODIMENT

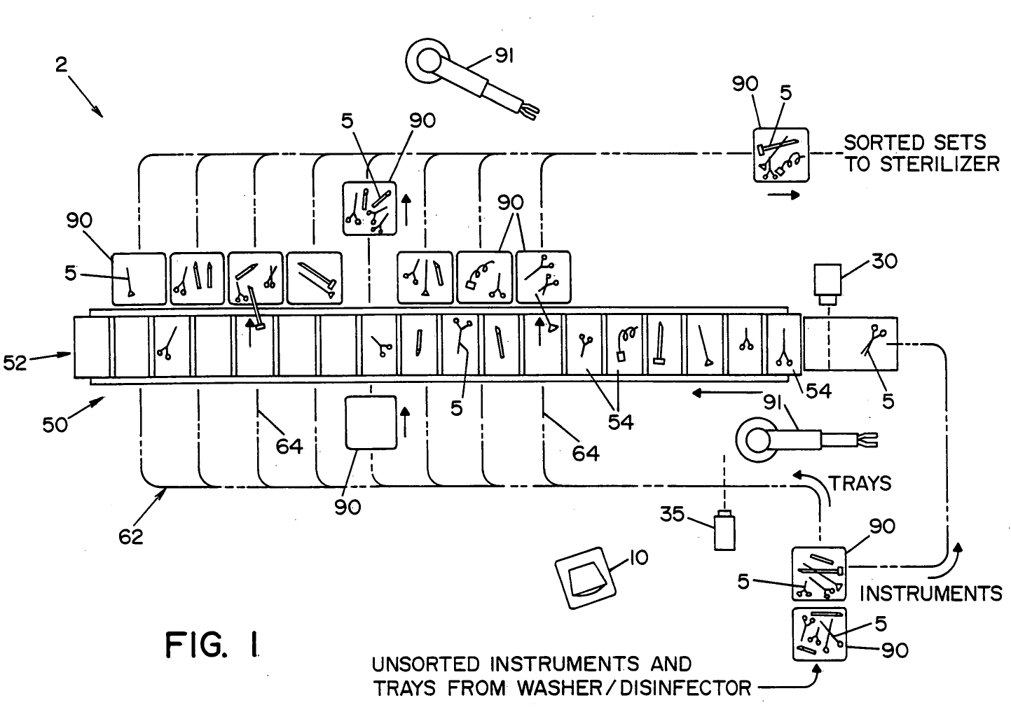

Referring now to the drawings wherein the showings are for the purposes of illustrating a preferred embodiment of the invention only and not for purposes of limiting same, FIG. 1 schematically illustrates an automated sorting system 2, according to a preferred embodiment of the present invention. Sorting system 2 is generally comprised of a tracking system 10, an imaging system 30, and a sorting apparatus 50.

According to a preferred embodiment of the present invention, imaging system 30 includes a CCD (charge coupled device) video camera (i.e., imager) for ‘reading’ a machine-readable code 6, as will be described in further detail below. For example, imaging system 30 may take the form of the AccuVision AV1220 Real Time Imaging System from Accu-Sort® Systems. inc. of Telford, Pa. The AccuVision AV1220 includes a fixed focus CCD camera. Accu-Sort® APC100 Decoder decodes all standard linear bar codes and two-dimensional symbols commonly used in high-speed material handling applications. In the illustrated embodiment, a second imaging system 35 is provided to ‘read’ a machine readable code 6 located on a bin or tray 90.

Machine-readable code 6 may take the form of symbol codes, including, but not limited to, a two-dimensional symbol code (such as Data Matrix symbology), a linear bar code, and the like. Preferably, a machine-readable code 6 is applied to each instrument 5 (FIG. 5) and to each tray 90 that is processed by automated sorting system 2, to serve as an identification code (ID). Machine-readable code 6 is applied to medical instruments 5 and trays 90, by way of example, and not limitation, engraving, laser etching, labels and the like. According to a preferred embodiment, each medical instrument 5 and tray 90 receives a unique identification code that identifies the specific instrument 5 and tray 90.

Data Matrix symbology is preferred for machine-readable code 6. In this regard, Data Matrix symbology employs Reed-Solomon error correction with data redundancy to provide fast and accurate code reading. Data Matrix symbology is scalable between a 1-mil square to a 14-inch square, and is therefore particularly well suited to marking small articles, such as medical instruments.

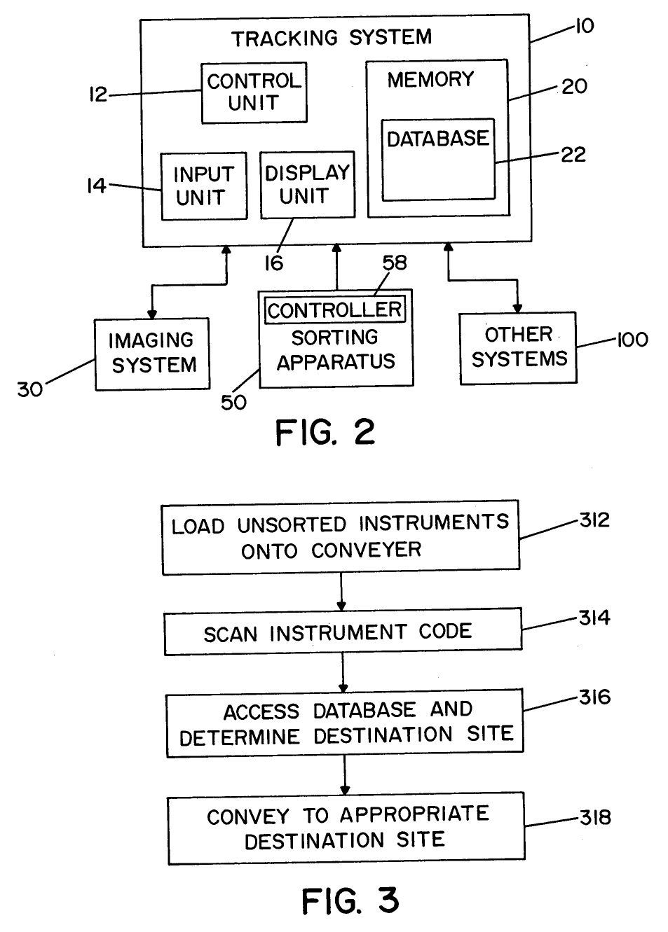

According to a preferred embodiment, sorting apparatus 50 includes a first conveyer unit 52 and a second conveyer unit 62 (illustrated in phantom in FIG. 1). First conveyer unit 52 is comprised of a plurality of transport members 54 that are driven by an endless loop (not shown). In a preferred embodiment, transport members 54 discharge articles from conveyer unit 52 in a direction transverse to the travel direction of transport member 54. In this regard, each transport member 54 may include conventionally-known cross-belts or tilt mechanisms. Second conveyer unit 62 is preferably a conventional conveyer apparatus having a plurality of travel paths 64 that pass under first conveyer unit 52. A controller 58 (FIG. 2) controls the operation of sorting apparatus 50. Sorting apparatus 50 may take the form of a compact sorting system, such as the Crisplant Compact Sorter (CCS). As will be described in further detail below, first conveyer unit 52 and second conveyer unit 62 respectively transport instruments 5 and trays 90 to destination sites identified by tracking system 10.

Referring now to FIG. 2, tracking system 10 preferably takes the form of a personal computer (PC), and includes a control unit 12, an input unit 14, a display unit 16 and memory 20. Control unit 12 may be a microprocessor. Input unit 14 may take the form of a keypad, a keyboard, a touchscreen, or the like. Display unit 16 may take the form of a video monitor, a LCD (liquid crystal display), a LED (light emitting diode) display device, or other display apparatus. Memory 20 may include, but is not limited to, RAM (random access memory), ROM (read only memory), hard disk drive, floppy disk drive, optical disc (e.g., compact disc and digital video disc), or other data storage device. Data is transmitted between tracking system 10 and imaging system 30, sorting apparatus 50 and other systems 100 (e.g., accounting systems, supplier computer systems, ordering systems, etc.), as will be explained in further detail below.

Memory unit 20 provides storage for a database 22 that stores information for assembling sets of instruments by one or more sort criteria. By way of example, and not limitation, database 22 may store information for sorting instruments according to: (1) medical instrument set lists, in order to sort instruments 5 into pre-defined medical instrument sets (e.g., a major basic surgery set); (2) instrument type, in order to sort instruments 5 into sets of like instruments; and (3) biocontamination reduction processes, in order to sort instruments 5 into sets of instruments that undergo the same biocontamination reduction process.

In a preferred embodiment, the sort criteria is selectable by a user through input unit 14. Database 22 may store tables of data associating each machine-readable code 6 with data including, but not limited to, destination site, instrument name, instrument type, medical instrument set, in-service date, maintenance due date, last sort date, biocontamination reduction process, serial number, storage location, owner name, and tray type. Using the information stored in database 22 tracking system 10 determines a destination site for each instrument 5, in accordance with the selected sort criteria. In the illustrated embodiment, sorted sets of instruments are stored in trays 90. Accordingly, tracking system 10 may also determine a destination site for each tray 90.

It should be understood that tracking system 10 may provide numerous functions in addition to those discussed above. In this respect, tracking system 10 may also provide a system for monitoring lost and stolen instruments, instrument inventories, instrument maintenance and repair schedules, and the like. Tracking system 10 may also provide report generating functions.

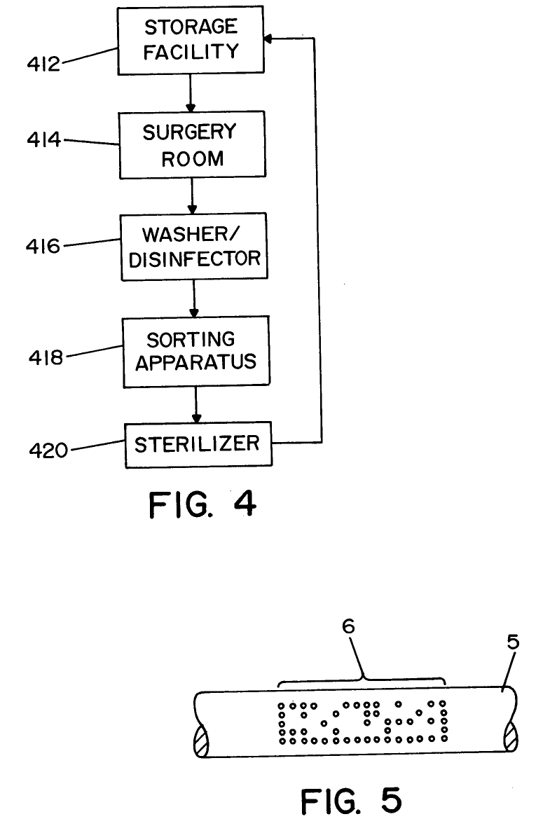

With reference to FIGS. 1, 3 and 4, operation of automated sorting system 2 will now be described in connection with a sorting operation, wherein instruments 5 are sorted into medical instrument sets (e.g., major basic surgery set). It should be appreciated that a preferred embodiment of the present invention is described with reference to the sorting of medical instruments 5. However, it is contemplated that the present invention also finds utility in connection with the sorting of other types of articles.

Sterile medical instruments 5 are initially sorted into medical instrument sets and are stored in trays 90 in a storage facility (e.g., a storage room) (step 412). When a medical instrument set is needed for a particular medical procedure, the set of sorted instruments 5 is transported from storage facility 412 to a surgery room (step 414). Following the completion of a medical procedure, the set of instruments 5, including “soiled” (i.e., contaminated) and unsoiled instruments, is typically disposed of at a central collection site, where the set of instruments 5 becomes co-mingled with sets of instruments 5 used in other medical procedures. Accordingly, medical instruments 5 become unsorted.

In order to re-use instruments 5, they must undergo one or more biocontamination reduction processes. Accordingly, the unsorted instruments 5 are transported to a washer/disinfector (step 416) to undergo a first biocontamination reduction process. Depending upon the type of instrument, instruments 5 may undergo different biocontamination reduction procedures (e.g., hand wash vs. machine wash), or may be loaded into different racks or containers associated with a biocontamination reduction apparatus. After the first biocontamination reduction process is completed, the unsorted instruments 5 are removed from the washer/disinfector, and transported to sorting apparatus 50 (step 418) in trays 90 to undergo a sorting process in advance of being transported to a sterilizer (step 420), wherein instruments 5 undergo a second biocontamination reduction process. It should be understood that instruments 5 may be removed from the washer/disinfector by an automated process (e.g., robotics), wherein instruments 5 are dumped onto trays 90 for transport to sorting apparatus 50, or directly placed onto sorting apparatus 50, without the use of trays 90. After processing by the sterilizer, instruments 5 may be returned to the storage facility in trays 90.

It should be appreciated that steps 416, 418 and 420 may take place offsite from the location of the medical procedure. For example, “soiled” instruments 5 may be collected at a hospital, and transported to a remote site for processing steps 416, 418 and 420. Sterilized sets of instruments 5 are returned to the hospital when required for a medical procedure.

As indicated above, instruments 5 may be transported to sorting apparatus 50 on a tray 90. A plurality of trays 90 may be loaded onto a mobile cart (not shown) to facilitate transportation of instruments 5 between different locations. Instruments 5 are unloaded from tray 90 onto transport members 54 of conveyer unit 52 (step 312). The unloading of tray 90 may be done manually (i.e., by hand), or by use of an automation device, including, but not limited to, one or more robotic arms (not shown). For instance, the robotic arms may be programmed to grab, transport, and release instruments 5. Robotic arm may use magnetics as a means for grabbing instruments 5.

Empty trays 90 are preferably loaded onto second conveyer unit 62, wherein they travel past a camera of second imaging system 35 that reads code 6 located oil trays 90. Code 6 is transmitted to controller 58 of sorting apparatus 50. Controller 58, in turn, relays code 6 to tracking system 10. Tracking system 10 accesses database 22 to determine a “destination site” for the corresponding tray 90. Tracking system 10 transmits data indicative of the destination site to controller 58 of sorting apparatus 50. Controller 58 controls conveyer unit 62 to convey tray 90 along a travel path 64 to reach the specified destination site. Trays 90 are conveyed to destination sites in advance of any instruments 5 that are to be conveyed to the same destination site.

Conveyer unit 52 moves instruments 5 past a camera of imaging system 30 that reads code 6 located on instruments 5 (step 314). Code 6 is transmitted to controller 58 of sorting apparatus 50. Controller 58, in turn, relays code 6 to tracking system 10. Tracking system 10 accesses database 22 to determine a “destination site” for the corresponding instrument 5 (step 316). For example, a destination site may be medical instrument sets (e.g., major basic surgery set). Tracking system 10 transmits data indicative of the destination site to controller 58 of sorting apparatus 50. Controller 58 controls conveyer unit 52 and transport members 54 to deliver instruments 5 to the destination site along conveyor unit 52 (step 318). It should be appreciated that imaging system 30 may also transmit a full image of instruments 5 for evaluation by tracking system 10 for any irregularities. In this manner, visibly damaged instruments 5 that need repair can be identified and removed.

As indicated above, transport members 54 may include cross-belts or tilt mechanisms to discharge articles from conveyer unit 52 in a direction transverse to the travel direction of transport member 54. In this manner, instruments 5 are deposited onto trays 90. Alternatively, an automation device, including, but not limited to, one or more robotic arms (not shown) may be used to transfer instruments 5 from first conveyer unit 52 into trays 90. Instruments 5 may also be transferred from first conveyer unit 52 to trays 90 by a manual process (i.e., by hand). Loaded trays 90 may then be loaded onto carts, and transported to a sterilizing apparatus.

As discussed above, instruments 5 may be sorted by sorting apparatus 50 into groups of like instruments. The sets of like instruments are then transported to a sterilizing apparatus to undergo a sterilization process. In accordance with another aspect of the present invention, the sets of like instruments may be loaded into a vending apparatus that operates in a manner similar to a conventional snack or beverage vending machine. In this regard, each set of like instruments is located in a separate compartment, slot or chute in the vending apparatus. The vending apparatus includes an input means for selecting a medical instrument set, and dispenses appropriate instruments from each compartment to assemble a specified medical instrument set. The medical instrument set can then be removed from the vending apparatus.

It should be understood that the sorting of instruments may take place at times other than between the washing/disinfection and sterilization processes. In this regard, instrument sorting may take place anytime it is desirable to group the instruments by a sort criteria.

Other modifications and alterations will occur to others upon their reading and understanding of the specification. It is intended that all such modifications and alterations be included insofar as they come within the scope of the invention as claimed or the equivalents thereof.

1. A method for processing medical instruments undergoing at least one biocontamination reduction process, comprising the steps of:
locating a plurality of medical instruments onto a conveyance means having a plurality of destination sites;
conveying each of the medical instruments past imaging means;
reading a machine-readable code located on each medical instrument to select from a plurality of destination sites a destination site associated with the medical instrument; and
conveying each medical instrument to the destination site associated therewith, wherein each of said plurality of destination sites collects a set of medical instruments according to a sort criteria.

2. A method according to claim 1, wherein said sort criteria is selected from the group consisting of: medical instrument sets, like instruments, and like biocontamination reduction processes.

3. A method according to claim 1, wherein said method further comprises:
accessing a database with the machine-readable code to obtain data indicative of a destination site corresponding to the sort criteria.

4. A method according to claim 3, wherein said database associates machine-readable codes with at least one of: destination site, instrument name, instrument type, medical instrument set, in-service date, maintenance due date, last sort date, biocontamination reduction process, serial number, storage location, and owner name.

5. A method according to claim 1, wherein said plurality of medical instruments are subject to a washing/disinfecting operation prior to locating the plurality of medical instruments onto the conveyance means.

6. A method according to claim 1, wherein the method further comprises:
transporting each set of medical instruments collected at each of the plurality of destination sites to a sterilizing apparatus; and
sterilizing each set of medical instruments.

7. A method according to claim 6, wherein said method further comprises:
storing each set of sterilized medical instruments in a storage facility.

8. A method according to claim 1, wherein each of said plurality of destination sites collects a set of like medical instruments, that are assembled into medical instrument sets comprised of medical instruments from at least two of said plurality of destination sites.

9. A method according to claim 1, wherein said machine-readable code is selected from the group consisting of: Data Matrix and bar code.

10. A method according to claim 1, wherein said method further comprises identifying visibly damaged medical instruments.

11. A system for automated sorting of a plurality of medical instruments, comprising:
an imaging system for reading a machine-readable code located on each medical instrument;
a tracking system using the machine-readable code to select a respective destination site for each medical instrument from a plurality of destination sites and transmitting destination site data to the sorting apparatus that identifies the respective destination site associated with each medical instrument; and
a sorting apparatus including:
conveyance means for conveying each of the medical instruments to the respective destination site selected from the plurality of destination sites to collect a set of medical instruments in accordance with a sort criteria, said conveyance means having a plurality of destination sites.

12. A system according to claim 11, wherein said sort criteria is selected from the group consisting of: medical instrument sets, like instruments, and like biocontamination reduction processes.

13. A system according to claim 11, wherein said sorting apparatus further comprises control means for controlling operation of the conveyance means

14. A system according to claim 11, wherein said tracking system includes a database for associating machine-readable codes with at least one of: destination site, instrument name, instrument type, medical instrument set, in-service date, maintenance due date, last sort date, biocontamination reduction process, serial number, storage location, and owner name.

15. A system according to claim 11, wherein said system further comprises a robotic arm for transferring the medical instruments onto said conveyance means.

16. A system according to claim 11, wherein said system further comprises a robotic arm for unloading medical instruments from the destination site.

17. A system according to claim 11, wherein said machine-readable code is selected from the group consisting of: Data Matrix and bar code.

18. A system according to claim 11, wherein said machine-readable code is permanently applied onto each medical instrument.

19. A system according to claim 11, wherein said imaging system identifies visibly damaged medical instruments.
